(19) United States
(12) Patent Application Publication
(10) Pub. No.: US 2003/0190117 A1
(43) Pub. Date: Oct. 9, 2003

(54) Optical switch assembly

(76) Inventor: Mingbao Zhou, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/304,574

(22) Filed: Nov. 25, 2002

(30) Foreign Application Priority Data
Apr. 4, 2002 (TW) 91204382

(51) Int. Cl. G02B 6/35

(52) U.S. Cl. 385/22; 385/33

(57) ABSTRACT

An optical switch assembly includes an input port (21), an output port (22), a switching device (23)′ and a driving device (25). The input port includes an input fiber (211), a capillary (212) retaining the input fiber and a first collimating lens (213) fixed at a front end of the capillary. The switching device locates between the input and output ports and includes a number of second collimating lenses (231) fixed in a connection plate (232). One end of the connection plate retains the second collimating lenses and a second end connects with the driving device. The output port is aligned with the input port and includes a number of output fibers (221) and a holder (222) retaining the output fibers. The driving device drives the switching device to position a second collimating lens in a light path between the input and output ports thereby effecting a switching between the input and output fibers.

### BACKGROUND OF THE INVENTION

1. Field of the Invention

The present invention relates to an optical switch assembly, and more particularly to a mechanical optical switch assembly.

2. Description of Prior Art

A variety of optical switches have been developed, including mechanical optical switches, electrical optical switches and laser diode optical switches. Mechanical optical switches have better performance, and are widely used in optical systems.

Referring to FIG. 7, U.S. Pat. No. 5,420,946 discloses a mechanical optical switch comprising an input port 610, a reflection assembly 630 and a plurality of output ports 620. The input port 610 includes an input fiber 611 and a gradient index (GRIN) lens 612. The GRIN lens 612 is for collimating light beams input from the input fiber 611. The reflection assembly 630 includes a curved reflector 631 (which is preferably a front surface coated mirror) and a mounting base 632, which defines a mounting hole 633 connecting with a motor (not shown). The output ports 620 each comprise an output fiber 621 and a GRIN lens 622. The output fibers 621 and the GRIN lenses 622 are disposed in a circular fashion. They are arranged such that they are in optical alignment with a reflection point on the curved reflector 631. The reflection point is the point where light beams transmitted from input fiber 611 strike the reflector 631 and reflect in a predetermined direction. When aligned with light beams reflected at the reflection point, the output fibers 621 receive the reflected light beams.

However, the output fibers 621 and the GRIN lenses 622 are arranged in a circular fashion, so that aligning the output fibers 621 and the GRIN lenses 622 with the reflection point is involved and makes assembling the switch inefficient.

Thus, it is desired to provide a reliable optical switch which can be more easily assembled.

### SUMMARY OF THE INVENTION

Accordingly, an object of the present invention is to provide an optical switch assembly which can be assembled easily and efficiently.

Another object of the present invention is to provide an optical switch assembly which has a low manufacturing cost.

To achieve the above objects, the present invention provides an optical switch assembly including an input port, an output port, a switching device and a driving device. The input port includes an input fiber, a capillary retaining the input fiber therein, and a first collimating lens. The first collimating lens is for collimating light beams emitted from the input fiber into parallel light beams. The switching device is located between the input port and the output port, and includes a plurality of second collimating lenses mounted in a connection plate. One end of the connection plate retains the second collimating lenses therein, and a second end of the connection plate connects to the driving device. The output port is aligned with the input port and includes a plurality of output fibers and a holder retaining the output fibers therein.

The above and other features of the invention, including various novel details of construction and combination of parts, will now be more particularly described with reference to the accompanying drawings.

### BRIEF DESCRIPTION OF THE DRAWINGS

FIG. 1 is a perspective view of an optical switch assembly in accordance with the present invention;

FIG. 2 is a cross-sectional view of the optical switch assembly of FIG. 1, taken along line II-II;

FIG. 3 is a cross-sectional view of a holder of FIG. 2, taken along line III-III

FIG. 4 is a cross-sectional view of a holder of FIG. 2, taken along line IV-IV

FIG. 5 is an essential optical paths diagram of the optical switch assembly of FIG. 1;

FIG. 6 is another essential optical paths diagram of the optical switch assembly of FIG. 1; and

FIG. 7 is a perspective view of a conventional optical switch.

### DETAILED DESCRIPTION OF PREFERRED EMBODIMENT

One preferred embodiment of an optical switch assembly according to the present invention will be described in conjunction with the drawings.

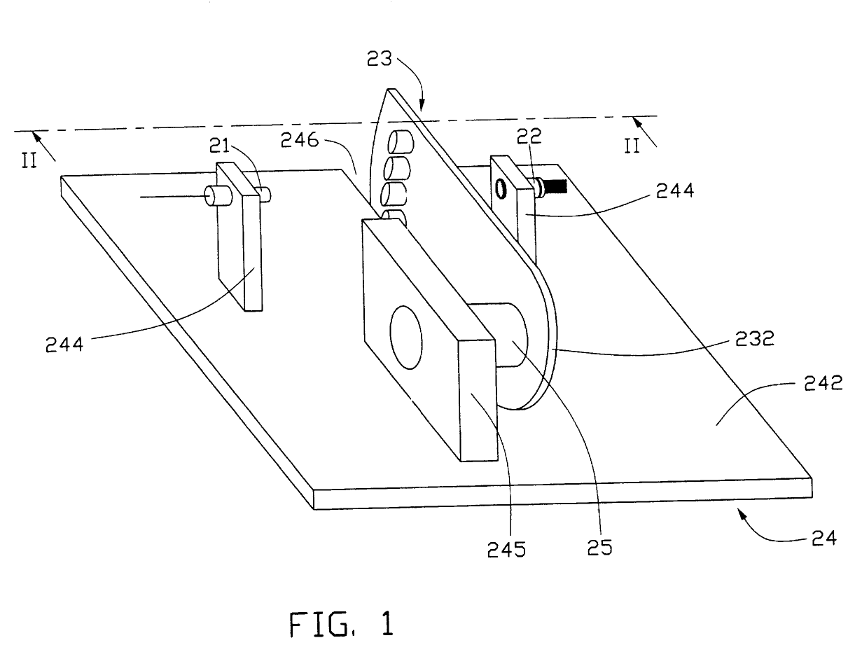

Referring to FIG. 1, an optical switch assembly in accordance with the present invention comprises an input port 21, a switching device 23, an output port 22, a driving device 25 connecting with the switching device 23, and a base 24.

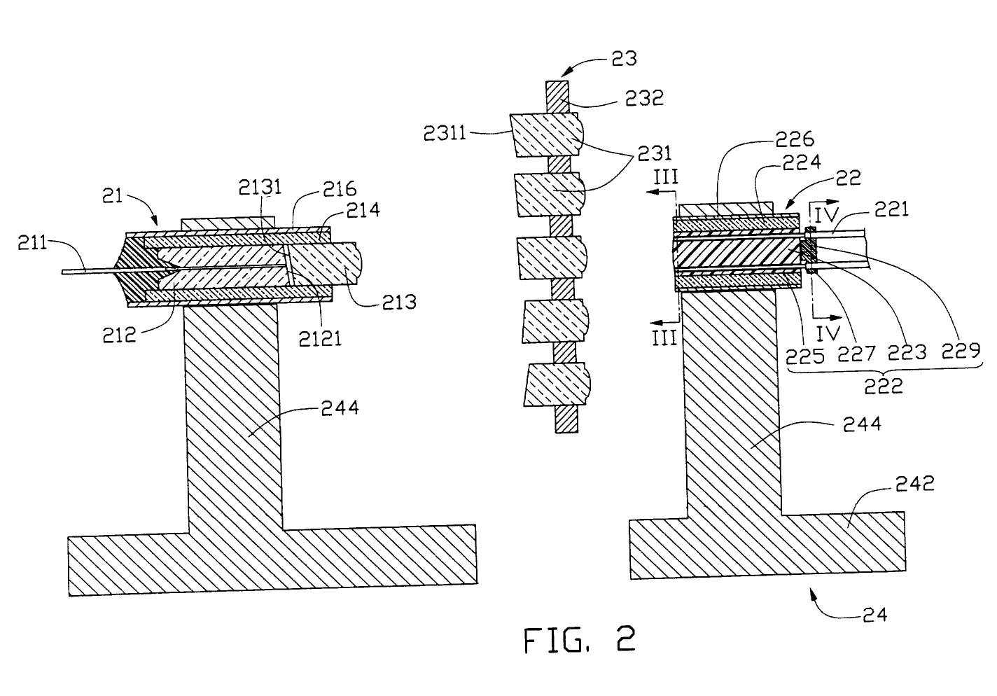

Referring to FIG. 2, the input port 21 comprises an input fiber 211, a capillary 212, a first collimating lens 213, a first sleeve 214 and a first outer sleeve 216. The input fiber 211 is fixed in the capillary 212 using epoxy resin (not labeled). The capillary 212 has an oblique forward end face 2121 which inclines at an angle preferably between 6 and 8 degrees. The first collimating lens 213 has an oblique rearward end face 2131 and an aspherical forward end face (not labeled) at opposite end thereof. The oblique rearward end face 2131 inclines at an angle matching that of the oblique forward end face 2121 of the capillary 212. The aspherical forward end face is designed to collimate light beams emitted from the input fiber 211 into parallel light beams. The first collimating lens 213 is made using a molding method. The first inner sleeve 214 encloses the capillary 212 and the first collimating lens 213, with the forward end face 2121 of the capillary 212 being spaced from and parallel to the rearward end face 2131 of the first collimating lens 213. The first outer sleeve 216 encloses the first inner sleeve 214.

The switching device 23 comprises a plurality of second collimating lenses 231 fixed in a connection plate 232. The connection plate 232 is oblong in shape, having a first end and a second end (not labeled). The second collimating lenses 231 are retained in the first end of the connection plate 232, arranged in an arc. The second end connects to the driving device 25. Each of the second collimating lenses 231 has an oblique rearward end face 2311 and an aspherical forward end face (not labeled). The oblique rearward end faces 2311 are inclined at a same angle relative to a longitudinal axis of the lens 231, but are each oriented in a different direction. The second collimating lenses 231 are made using a molding method. In operation, the connection plate 232 is driven to rotate by the driving device 25, whereby each of the second lenses 231 can be precisely moved into an optical path between the input and output ports 21, 22.

Also referring to FIG. 2, the output port 22 comprises a plurality of output fibers 221, a holder 222, a second inner sleeve 224, and a second outer sleeve 226. The holder 222 comprises a core 223, a core sleeve 225, a support portion 229 and a ring 227.

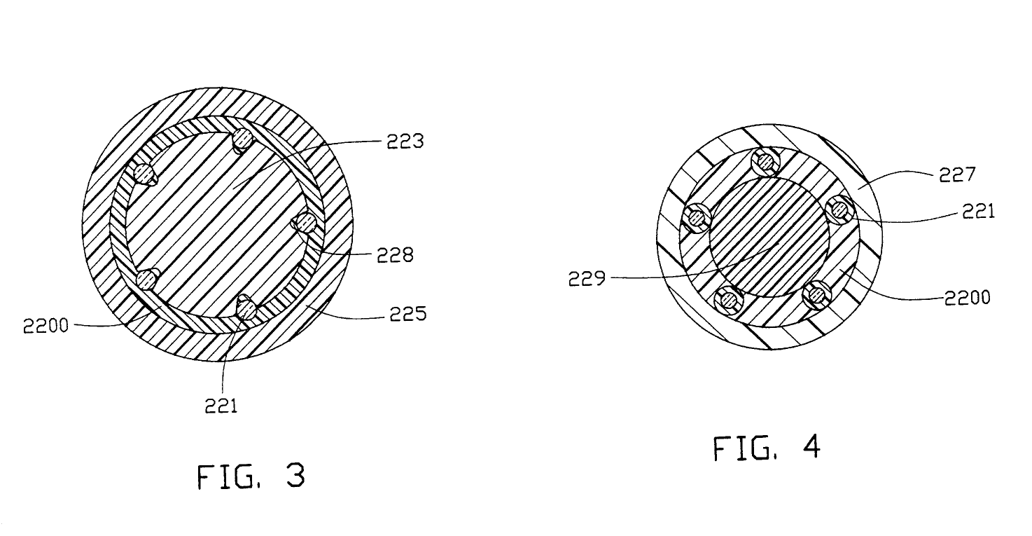

Referring to FIGS. 2 and 3, the core 223 forms a plurality of longitudinally-oriented V-shaped grooves 228 in an outer surface thereof. Protective jackets (not labeled) are stripped from ends of the output fibers 221, to expose a bare output optical fiber core. Each of the output fiber cores is fixed in a corresponding V-shaped groove 228 using epoxy resin 2200. The core sleeve 225 encloses the core 223 and the output optical fiber cores therein. The second inner sleeve 224 encloses the core sleeve 225. The second outer sleeve 226 encloses the second inner sleeve 224.

Referring to FIGS. 2 and 4, the support portion 229 is attached to an end (not labeled) of the core 223 using epoxy resin (not labeled). The ring 227 surrounds the support portion 229. Unstripped portions of the output fibers 221 are sandwiched between the support portion 229 and the ring 227 and are fixed therein using epoxy resin 2200.

Referring to FIG. 1, the base 24 comprises a substrate 242, two supporting arms 244 extending upwardly from the substrate 242 and a bracket 245. The two supporting arms 244 are for holding the input and output ports 21, 22. An opening 246 is defined through one side of the substrate 242, for rotation of the connection plate 232 therein.

The driving device 25 comprises a shaft (not separately labeled) which connects to the second end (not labeled) of the connection plate 232. The shaft is supported in the bracket 245 and connects to a remainder of the driving device (not shown).

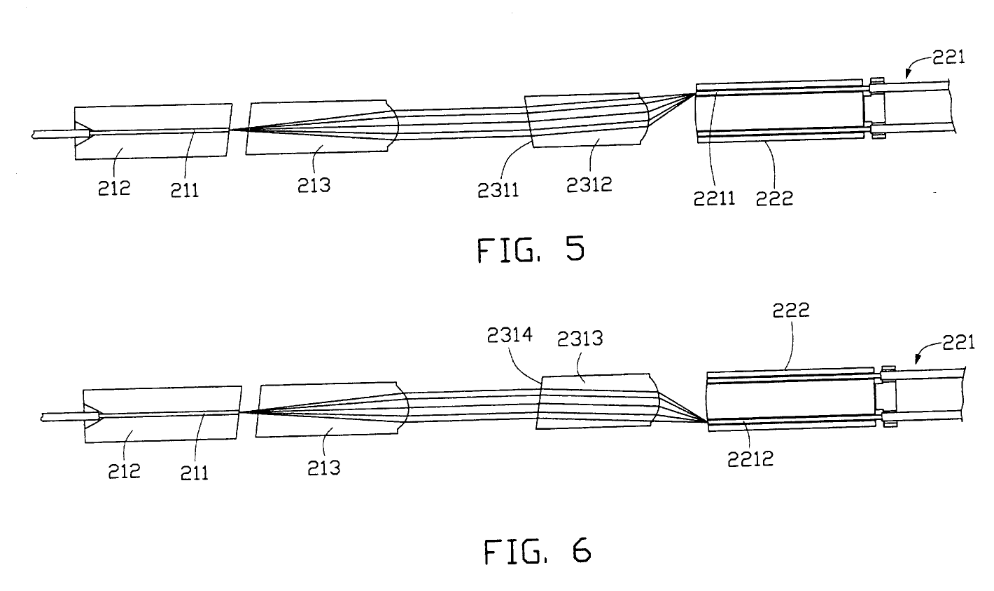

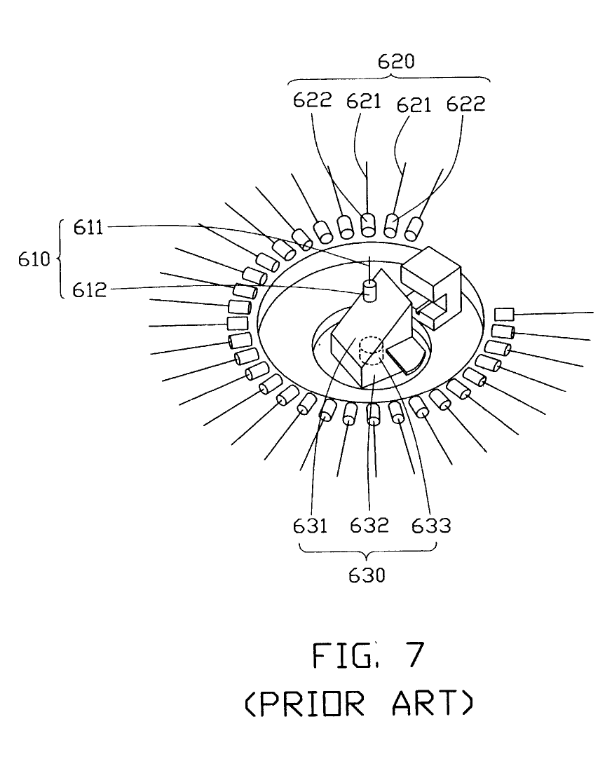

Referring to FIGS. 1 and 5, one specific second collimating lens 2312 is positioned in the optical path between the input and output ports 21, 22. Light beams (not labeled) emitting from the input fiber 211 are transmitted through the first collimating lens 213. The aspherical forward end face of the first collimating lens 213 transmits the light beams as parallel light beams (not labeled). Said parallel light beams are then refracted an angle by the oblique rearward end face 2311, and are transmitted through the second collimating lens 2312. The refracted parallel light beams are focused by the aspherical forward end face of the second collimating lens 2312 and pass through an end of a predetermined output fiber 2211 and are transmitted through the predetermined output fiber 2211.

Referring to FIGS. 1 and 6, another second collimating lens 2313 is positioned in the optical path between the first and second ports 21, 22. Since an angular orientation of the oblique rearward end face 2314 of the second collimating lens 2313 is different from that of the oblique rearward end face 2311 of the second collimating lens 2312, the light beams are focused on an end of a different output fiber 2212 and are transmitted through the output fiber 2212. For each different second collimating lens 231 placed in the optical path between the input and output ports 21, 22, the light beams are focused on a different output fiber 221, whereby optical switching of the light path is achieved.

Compared with the conventional mechanical switch, the optical switch assembly of the present invention can be assembled more easily. Furthermore, the collimating lenses 213, 231 are made by a molding method and have low manufacturing cost.

Although the present invention has been described with reference to a specific embodiment, it should be noted that the described embodiment is not necessarily exclusive and that various changes and modifications may be made to the described embodiment without departing from the scope of the invention as defined by the appended claims.

What is claimed is:

1. An optical switch assembly for switching light beams from one optical input fiber between a plurality of optical output fibers comprising:
an input port, including a first collimating lens, the first collimating lens being aligned with the input fiber;
a switching device located between the input port and the output port, comprising a plurality of second collimating lenses, each of the second collimating lenses having an oblique end face;
an output port including a plurality of output fibers and a holder retaining the output fibers therein, the holder comprising a core and a core sleeve, the core sleeve enclosing the core, the output fibers being sandwiched between the core and the core sleeve, and an optical path being defined between the input and output ports; and
a driving device engaging with and selectively moving the switching device to position a selected second collimating lens in the optical path;
wherein when light beams emitted from the input fiber are transmitted through the first collimating lens, the first collimating lens transmits the light beams as parallel light beams, said parallel light beams are then refracted an angle by the oblique end face of a second collimating lens positioned in the optical path and are transmitted through the second collimating lens, the refracted parallel light beams are then focused on an end of a predetermined output fiber and are transmitted through the predetermined output fiber.

2. The optical switch assembly in accordance with claim 1, wherein the input port further comprises a capillary, and the capillary fixes the input fiber therein.

3. The optical switch assembly in accordance with claim 1, wherein the oblique end faces of the second collimating lenses all incline at a same angle relative to axis of the second collimating lenses, but are oriented in different directions.

4. The optical switch assembly in accordance with claim 1, wherein the switching device further comprises a connection plate, the second collimating lenses are fixed in one end of the connection plate arranged along an arc, and the driving device connects with a second end of the connection plate.

5. The optical switch assembly in accordance with claim 1, further comprising a base, the base comprising a substrate, two supporting arms and a bracket projecting upwardly from the substrate, wherein the supporting arms respectively hold the input and output ports therein.

6. The optical switch assembly in accordance with claim 1, wherein the core of the holder defines a plurality of V-shaped grooves in a longitudinal direction in an outside surface thereof.

7. The optical switch assembly in accordance with claim 1, wherein the holder further comprises a support portion and a ring, the support portion being attached to one end of the core, the plurality of output fibers being fixed around an outside surface of the support portion, and the ring enclosing the output fibers and the support portion.

8. An optical switch assembly for switching light beams from one optical input fiber between a plurality of optical output fibers comprising:
an input port, including a first collimating lens, the first collimating lens being aligned with the input fiber;
a switching device located between the input port and the output port, comprising a plurality of second collimating lenses;
an output port including a plurality of output fibers and a holder retaining the output fibers therein, the holder comprising a core and a core sleeve, the core sleeve enclosing the core, the output fibers being sandwiched between the core and the core sleeve and relatively spaced far away from one another, and an optical path being defined between the input and output ports; and
a driving device engaging with and selectively rotatably moving the switching device to position a selected second collimating lens in the optical path;
wherein when light beams emitted from the input fiber are transmitted through the first collimating lens, the first collimating lens transmits the light beams as parallel light beams, said parallel light beams are then refracted an angle by the selected second collimating lens positioned in the optical path and are transmitted through the second collimating lens, the refracted parallel light beams are then focused on an end of a predetermined output fiber and are transmitted through the predetermined output fiber; wherein
the angles defined by the second collimating lens are mutually different from one another.
